(19) United States
(12) Patent Application Publication
(10) Pub. No.: US 2009/0212949 A1
(43) Pub. Date: Aug. 27, 2009

(54) Alarm, and detection and alarming method thereof

(75) Inventors: Chu-Chia Tsai, Taipei Hsien (TW); Wen-Chin Wu, Taipei Hsien (TW); Pei-Ling Lai, Taipei Hsien (TW); Chia-Hsien Li, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/219,411

(22) Filed: Jul. 22, 2008

(30) Foreign Application Priority Data
Feb. 21, 2008 (TW) 097106151

(51) Int. Cl. G08B 13/14

(52) U.S. Cl. 340/571

(57) ABSTRACT

An alarm and a detection and alarming method thereof are disclosed. The alarm is used to monitor a computer system. The alarm comprises a control module, a motion sensor and a user input interface circuit. The method comprises the following steps: activating an alarming procedure by the user input interface circuit; detecting whether a motion signal is generated or not; if yes, executing an instruction inputting procedure; determining whether a correct instruction is inputted or not; if yes, deactivating the alarming procedure; and if not, executing an alarm.

### BACKGROUND OF THE INVENTION

1. Field of the Invention

The present invention relates to an alarm, and, more particularly, to an alarm for a computer system that detects an unusual situation and alarms.

2. Description of the Related Art

With improvements in technology, computer systems are increasingly mobile. However, with this increased mobility comes the risky that a portable computer might be stolen. Sensitive personal information stored in the portable computer might also be accessed.

In the prior art, a portable computer lock has been developed. This lock is used to prevent the theft of a portable computer. The portable computer lock has a steel cable which can fix the portable computer in a particular fix place or to a table leg. However, it is very inconvenient to fix or remove the portable computer lock. In addition, the thief may damage the fix place or the steel cable and thus steal the portable computer. This type of lock is therefore not a very effective deterrent. In the case of sensitive information, although the user may protect the information with a screen saver or a hard disk password, this type of password is easy to crack and thus is not an effective deterrent.

It is therefore desirable to provide an alarm to solve the aforementioned problems.

### SUMMARY OF THE INVENTION

A main objective of the present invention is to provide an alarm for the computer system to detect an unusual situation and execute an alarm.

Another objective of the present invention is to provide a detection and alarming method.

In order to achieve the above mentioned objectives, the present invention provides an alarm disposed in a computer host of a computer system. The computer host comprises a power supply device to supply the power. The alarm receives the power from the computer host. The alarm comprises a control module, a motion sensor, and a user input interface circuit. The motion sensor is electrically connected to the control module to detect the motion of the alarm. The user input interface circuit is electrically connected to the control module to allow a user to activate or deactivate the motion sensor, wherein the control module is used for detecting whether the motion sensor generates a motion signal or not when the motion sensor is activated. If a motion signal is generated, the computer system executes an alarm.

The detection and alarming method of the present invention comprises the following steps: detecting whether an alarming procedure of the computer system is activated or not; if an alarming procedure is activated, detecting whether a motion signal for the computer system is generated or not; if yes, executing an instruction inputting procedure; determining whether a correct instruction is inputted to the computer system or not; if yes, lifting the alarming procedure; and if no, executing an alarm.

Other objects, advantages, and novel features of the invention will become more apparent from the following detailed description when taken in conjunction with the accompanying drawings.

### BRIEF DESCRIPTION OF THE DRAWINGS

FIG. 1 is a system block drawing of an alarm and a computer system of the present invention.

FIG. 2 is a schematic drawing of an alarm setup on a computer host of the present invention.

FIG. 3 is a schematic drawing of the first embodiment of the user input interface circuit of the present invention.

FIG. 4 is a schematic drawing of the second embodiment of the user input interface circuit of the present invention.

FIG. 5 is a schematic drawing of the third embodiment of the user input interface circuit of the present invention.

FIG. 6 is a flowchart of a detection and alarming method of the present invention.

FIG. 7 is a flowchart of an alarm deactivation method of the present invention.

### DETAILED DESCRIPTION OF THE PREFERRED EMBODIMENT

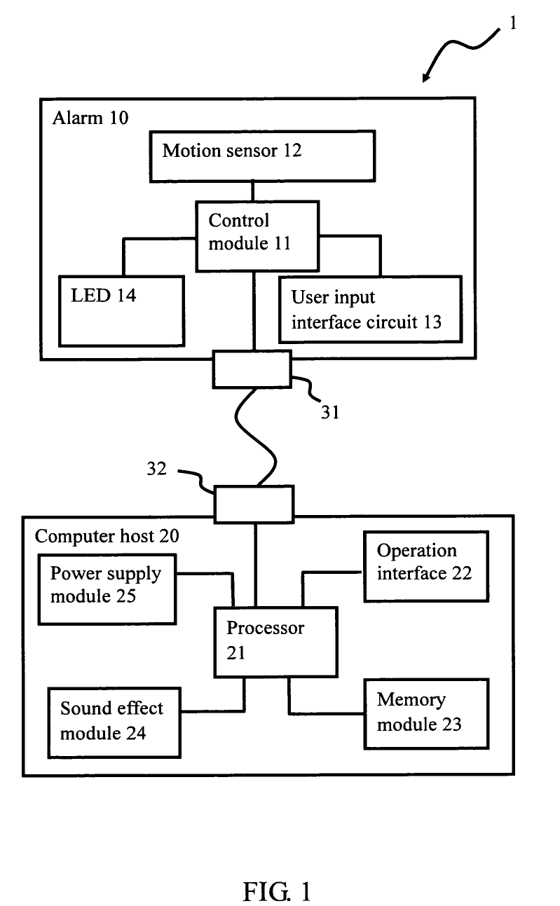

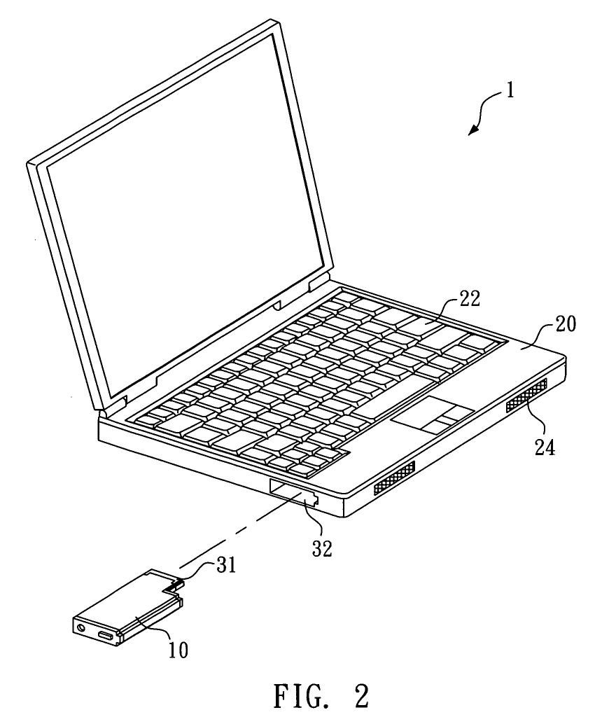

Please refer to FIG. 1 and FIG. 2. FIG. 1 is a system block drawing of an alarm and a computer system of the present invention. FIG. 2 is a schematic drawing of an alarm setup on a computer host of the present invention.

A computer system 1 can be a portable computer or a desktop computer. In this embodiment, the computer system 1 is a portable computer. The computer system 1 comprises an alarm 10 and a computer host 20. The alarm 10 is connected with a slot 32 of the computer host 20 by the connect interface 31. The alarm 10 can execute an alarming procedure to detect whether an unusual situation occurs or not, and cause the computer host 20 to execute an alarm. The alarming procedure will be explained in detail in the following description.

The alarm 10 comprises a control module 11, a motion sensor 12, a user input interface circuit 13, and a LED 14, and all of the above-mentioned elements are electrically connected to each other. The control module 11 is electrically connected to the computer host 20 via the connect interface 31. The motion sensor 12 has a motion detecting function. When the alarm 10 moved, the motion sensor 12 can transmit a motion signal to the control module 11. As the motion sensor 12 is familiar to those who are skilled in the art, it will not be further described for the sake of brevity. The user input interface circuit 13 is used to allow the user to control the alarm to activate or deactivate the alarm 10 or interrupt the execution of the motion sensor 12. All of the embodiments of the user input interface circuit 13 will be explained in detail in the following description. Moreover, an LED 14 can be disposed in the alarm 10 to indicate whether the alarm 10 is working or not.

The computer host 20 comprises a processor 21, an operation interface 22, a memory module 23, a sound effect module 24, and a power supply module 25, and all of the above-mentioned elements are electrically connected to each other. The processor 21 is used to execute all the procedures of the computer host 20. The operation interface 22 can be a keyboard or a mouse to allow the user to operate the computer. The memory module 23 can be a module which has a memory function in the computer host 20, such as a memory or a hard disk, to store the information of the procedures of the alarm 10. The sound effect module 24 can be a speaker or a buzzer and is used to produce sound. The power supply module 25 can be a battery or the external power supply of the computer host 20; the invention is not limited to these two options. The power supply module 25 is used to provide the power needed by the computer host 20.

The connect interface 31 and the slot 32 can be an Express interface or a PCMCIA (Personal Computer Memory Card International Association) interface. The alarm 10 can receive power which is supplied by the power supply module via the connect interface 31. If the connect interface 31 is the Express interface, the computer host 20 can transmit the power to the alarm 10 via the Express interface, the design of which allows provision of 3.3 volts of electricity. Therefore, when the computer host 20 is in standby or sleep mode, it can still provide 3.3 volts of electricity to the alarm 10 so that the alarm 10 can execute the detection procedure. In addition, the alarm 10 can read the information of processing procedures which are stored and set in the memory module 23 directly. Moreover, when the alarm is executed, the alarm 10 can control the sound effect module 24 of the computer host 20 to produce sound. Therefore, the alarm 10 requires no battery, memory, or speaker, which will greatly reduce manufacturing costs.

The alarm 10 can be a standard size, like ExpressCard/54 or ExpressCard/34. In this embodiment, the alarm 10 is the ExpressCard/54, but the invention is not limited to these two types.

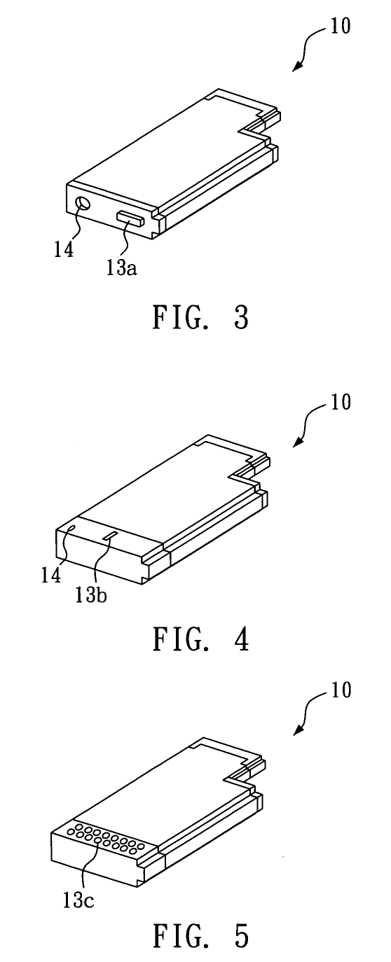

Please refer to FIG. 3 to FIG. 5. FIG. 3 is a schematic drawing of the first embodiment of the user input interface circuit of the present invention. FIG. 4 is a schematic drawing of the second embodiment of the user input interface circuit of the present invention. FIG. 5 is a schematic drawing of the third embodiment of the user input interface circuit of the present invention.

In FIG. 3, the user input interface circuit 13 can be a button switch 13a. When the user presses the button switch 13a, it can activate or deactivate the alarm 10.

Alternatively, as illustrated in FIG. 4, the user input interface circuit 13 also can be a fingerprint identification module 13b. The fingerprint identification module 13b can identify the fingerprint of the user to activate or deactivate the alarm 10 without inputting another instruction.

Moreover, the user input interface circuit 13 can be a touch display panel 13c, as illustrated in FIG. 5. The touch display panel 13c can display symbols, such as characters or numbers for the user to touch it as input. The user can operate the touch display panel 13c directly, without operating the operation interface 22 of the computer host 20. The symbols shown on the touch display panel 13c can be displayed a random order and prevent bystanders from guessing the instruction from the inputting location. However, the embodiments of the user input interface circuit 13 as mentioned above are just examples. The embodiments mentioned above can coexist within the same device. For example, the user input interface circuit 13 can comprise the button switch 13a and the fingerprint identification module 13b at the same time.

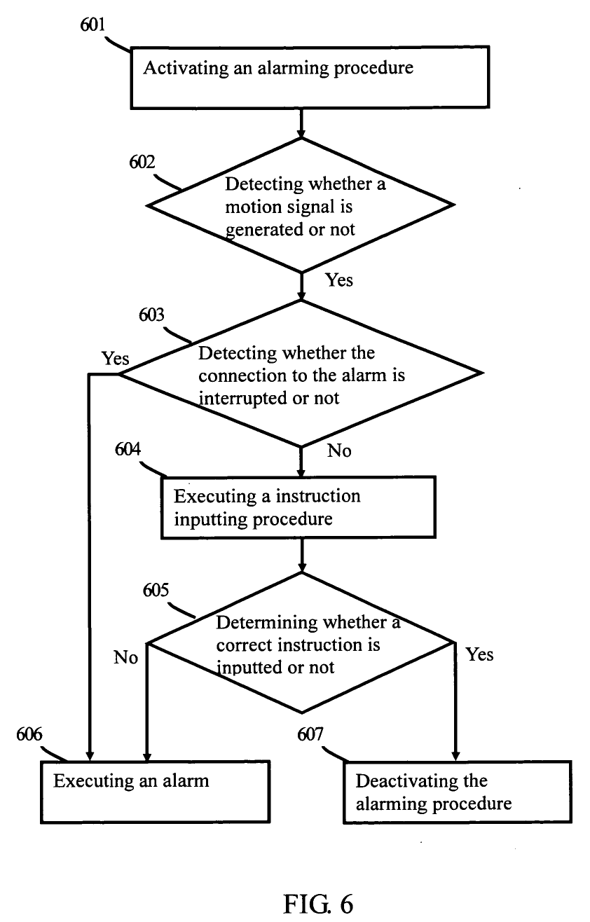

Please refer to FIG. 6. FIG. 6 for a flowchart of a detection and alarming method of the present invention. It must be noted that even though the following description explains the detection and alarming method of the present invention with an alarm 10, the detection and alarming method of the present invention can be carried out by devices other than the alarm 10.

First, step 601: activating an alarming procedure.

After disposing the alarm 10 in the computer host 20, the user can activate the alarming procedure with the control button switch on the user input interface circuit 13. After activating the alarming procedure, the computer system 1 might execute the screen saver mode or shut down the screen. At this time, the LED 14 of the alarm 10 can emit a light to indicate that the alarm 10 is executing the alarming procedure.

Step 602: detecting whether a motion signal is generated or not.

When the alarm 10 executes the alarming procedure, the control module 11 will detect whether a motion signal is generated. The motion signal includes the situation that the alarm 10 is moved or removed. If the alarm 10 is removed from the slot 32, the control module 11 will also generate the motion signal. When the alarm lo is moved, the motion sensor 12 will detect the motion of the alarm 10 immediately and generate the motion signal to notify the control module 11.

If the motion signal is generated, then step 603 is executed.

Step 603: detecting whether the connection to the alarm is interrupted or not.

In step 602, if the alarm 10 is moved, the electrical connection between the alarm 10 and the computer host 20 will be interrupted. Such an interruption will cause the computer host 20 to execute step 606 directly. If the alarm 10 is still electrically connected to the computer host 20, the computer host 20 will execute step 604.

Step 604: executing an instruction inputting procedure.

Meanwhile, the control module 11 will execute an instruction inputting procedure in a specific time to request that the user input an instruction. For example, the computer host 20 can display an instruction inputting window on the screen so that the user can input the instruction by the user input interface circuit 13 or the operation interface 22. Alternatively, the control module 11 can wait passively for the user to press the related control button switch by himself within a user-specified time and execute the instruction inputting procedure, wherein the instruction has been set by the user in advance. If the user input interface circuit 13 is a fingerprint identification module 13b, the fingerprint identification module 13b can be used to input the fingerprint of the user as the instruction. The fingerprint identification module 13b will recognize whether the fingerprint has been set before.

Please note that in the above description, it is mentioned that a specific time delay can be set by the user. Such an adjustable alarming time delay can allow the user to set the alarming delay time to a duration which the user feels is neither too short or too long, thus improving the convenience of operation of the alarm 10.

Step 605: determining whether a correct instruction is inputted or not.

After the user inputs the instruction by the user input interface circuit 13 or the operation interface 22, the control module 11 will determine whether the input instruction is the correct instruction or not. If an incorrect instruction is inputted or an instruction is not inputted in the specific time, step 606 will be performed. If the correct instruction has been inputted, step 607 will be performed.

Step 606: executing an alarm.

If the incorrect instruction is inputted or the user does not input the instruction in the specific time, the control module 11 will control the processor 21 of the computer host 20 to execute alarming. Moreover, if the electrical connection of the alarm 10 to the computer host 20 is interrupted in step 603, the processor 21 will execute the alarm directly. When executing the alarm, the computer host 20 will be locked; for example, the operating system will be locked to prevent any user from operating the computer host 20. Concurrently, the sound effect module 24 will be used to produce sound to deter the thief.

Step 607: deactivating the alarming procedure.

If the correct instruction is inputted, the control module 11 will deactivate the alarming procedure directly. In addition, the LED 14 will be deactivated to indicate to the user that the alarm 10 has been deactivated.

By the above procedure, the alarm 10 can achieve the intention of producing the alarm. Moreover, the computer system 1 can use the above procedures to protect the hard disk. When the computer host 20 suffers an impact, the motion sensor 12 will sense the motion and the control module 11 will control the write head of the hard disk to prevent damage to the hard disk.

However, the method of the alarm 10 executing the alarm is not limited to the above method. The method can also include execution of the alarm if the operation interface 22 of the computer host 20 is operated at the alarming procedure.

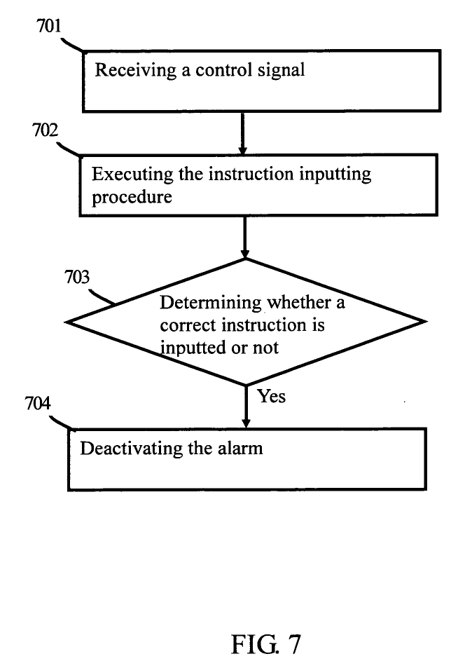

When the alarm has been activated, the user can also deactivate the alarm by the alarm 10. Please refer to FIG. 7. FIG. 7 is a flowchart of an alarm deactivation method of the present invention.

First, step 701: receiving a control signal.

When the alarm is activated, the user uses the user input interface circuit 13 to press a control button switch. Then the control module 11 will receive a control signal and execute step 702.

Step 702: executing the instruction inputting procedure.

Meanwhile, the control module 11 executes the instruction inputting procedure and allows the user to input the instruction by the user input interface circuit 13 or the operation interface 22. Because this step is similar to step 604, it will not be further described for the sake of brevity.

Step 703: determining whether a correct instruction is inputted or not.

The control module 11 will determine whether a correct instruction is inputted. If the user inputs the correct instruction, the control module 11 will execute step 704.

Step 704: deactivating the alarm.

The control module 11 will control the processor 21 of the computer host 20 to deactivate the alarm. The alarm 10 will return to the status that it was in before the computer host 20 executed the alarming procedure. In addition, the LED 14 will be deactivated to show the user that the alarm 10 has been deactivated.

Moreover, the detection and alarming method of the present invention is not limited as the above mentioned description, and the sequence of steps of the detection and alarming method can also be changed. The instruction or the specific times above mentioned can be changed by the user; the type of event that can trigger an alarming also can be set by the user. These settings will be stored in the memory module 23.

Although the present invention has been explained in relation to its preferred embodiment, it is to be understood that many other possible modifications and variations can be made without departing from the spirit and scope of the invention as hereinafter claimed.

What is claimed is:

1. An alarm for use in a computer system, wherein the computer system has a computer host and the alarm receives power from the computer host,
the alarm comprising:
a control module for electrically connecting to the computer host;
a motion sensor electrically connected to the control module, for detecting whether the alarm is moving or not; and
a user input interface circuit electrically connected to the control module, allowing a user to activate or deactivate the motion sensor, wherein the control module is used for detecting whether the motion sensor generates a motion signal after the motion sensor is activated, and if yes, causes the computer system to execute an alarm.

2. The alarm as claimed in claim 1, wherein the user input interface circuit further is used to deactivate the alarm or the motion sensor by an instruction input mode.

3. The alarm as claimed in claim 1, wherein the user input interface circuit is a button switch.

4. The alarm as claimed in claim 1, wherein the user input interface circuit is a fingerprint identification module.

5. The alarm as claimed in claim 1, wherein the user input interface circuit is a touch display panel.

6. An alarm for using in a computer system, wherein the computer system comprises a computer host, and the alarm receives power from the computer host, the alarm comprising:
an Express interface or a PCMCIA (Personal Computer Memory Card International Association) interface electrically connected to the computer host for receiving the power;
a control module for electrically connecting to the interface;
a motion sensor electrically connected to the control module for detecting whether the alarm is moving or not; and
a user input interface circuit electrically connected to the control module allowing a user to activate or deactivate the motion sensor, wherein the control module is used for detecting whether the motion sensor generates a motion signal after the motion sensor is activated, and if yes, causes the computer system to execute an alarm.

7. A computer system having an alarm comprising:
a computer host having a power supply module used for supplying power; and
an alarm electrically connected to the computer host for receiving the power, the alarm comprising:
a control module for electrically connecting to the computer host;
a motion sensor electrically connected to the control module, for detecting whether the alarm is moving or not; and
a user input interface circuit electrically connected to the control module, allowing a user to activate or deactivate the motion sensor, wherein the control module is used for detecting whether the motion sensor generates a motion signal after the motion sensor is activated, and if yes, causes the computer system to execute an alarm.

8. The computer system as claimed in claim 7, wherein the user input interface circuit further is used to deactivate the alarm or the motion sensor by an instruction input mode.

9. The computer system as claimed in claim 8, wherein the user input interface circuit is a button switch.

10. The computer system as claimed in claim 8, wherein the user input interface circuit is a fingerprint identification module.

11. The computer system as claimed in claim 8, wherein the user input interface circuit is a touch display panel.

12. The computer system as claimed in claim 7, wherein the computer host further comprises an operation interface for using a instruction input mode to deactivate the alarm or the motion sensor.

13. The computer system as claimed in claim 7, wherein the computer host further comprises a sound effect module; the control module is used for controlling the sound effect module to produce sound when the alarm is executed.

14. A computer system having an alarm comprising:
a computer host having a power supply module used for supplying power; and
an alarm electrically connected to the computer host for receiving the power, the alarm comprising:
an Express interface or a PCMCIA interface electrically connected to the computer host for receiving the power;
a control module for electrically connecting to the interface;
a motion sensor electrically connected to the control module for detecting whether the alarm is moving or not; and
an user input interface circuit electrically connected to the control module allowing a user to activate or deactivate the motion sensor,
wherein the control module is used for detecting whether the motion sensor generates a motion signal after the motion sensor is activated, and if yes, causes the computer system to execute an alarm.

15. A method of detection and alarming for a computer system motion, the method comprising:
detecting whether an alarming procedure of the computer system is activated or not;
if an alarming procedure is started, detecting whether a motion signal for the computer system is generated or not;
if yes, executing a instruction inputting procedure;
determining whether a correct instruction is inputted to the computer system or not;
if yes, lifting the alarming procedure; and
if no, executing an alarm.

16. The detection and alarming method as claimed in claim 15 further comprising the following steps:
when the computer system executes the instruction inputting procedure, determining whether the correct instruction is inputted within a specific time or not; and
if not, executing the alarm.

17. The detection and alarming method as claimed in claim 15 further comprises: using a user input interface circuit to activate the alarming procedure or input the instruction.

18. The detection and alarming method as claimed in claim 15, wherein the step of executing an alarm comprises:
controlling a sound effect module of the computer system to produce sound; and
locking the computer system.

19. The detection and alarming method as claimed in claim 15, wherein the step of detecting whether the motion signal for the computer system has been generated further comprises:
detecting whether the alarm has generated a motion signal or not; and
detecting whether the connection between the computer system and the alarm is interrupted or not.

20. The detection and alarming method as claimed in claim 15, further comprising a step of deactivating the alarm, the step comprising:
receiving a control signal;
executing the instruction inputting procedure;
determining whether a correct instruction is inputted; and
if yes, deactivating the alarm.
